(19) United States
(12) Patent Application Publication
(10) Pub. No.: US 2026/0083535 A1
(43) Pub. Date: Mar. 26, 2026

(54) AN INTRAORAL SCANNING DEVICE WITH A SUPPLY ASSEMBLY UNIT

(71) Applicant: 3SHAPE A/S, Copenhagen K (DK)

(72) Inventors: Michael PEDERSEN, Copenhagen K (DK); Alexander Bruun CHRISTIANSEN, Copenhagen K (DK)

(73) Assignee: 3SHAPE A/S, Copenhagen K (DK)

(21) Appl. No.: 19/114,036

(22) PCT Filed: Sep. 18, 2023
(86) PCT No.: PCT/EP2023/075554

§ 371 Date: Mar. 21, 2025

(30) Foreign Application Priority Data
Sep. 21, 2022 (EP) 22197007.2

(51) Int. Cl. A61C 9/00; H02M 3/158; H04N 9/31; H05B 45/375; H05B 45/38; H05B 47/155; H05B 47/16

(52) U.S. Cl. CPC A61C 9/006; H02M 3/1582; H05B 45/375; H05B 45/38; H05B 47/155; H05B 47/16; H04N 9/3155; H04N 9/3176

(57) ABSTRACT

An intraoral scanning device configured to acquire intraoral scan data from a three-dimensional dental object. The intraoral scanning device includes: a projector unit configured to emit light at least onto the dental object of a patient. The projector unit includes a light source; an image sensor configured to acquire reflected light from the dental object; a processing unit configured to process the acquired reflected light into 2D intraoral scan data and/or 3D intraoral scan data, a battery unit configured to supply a DC voltage, a supply assembly unit configured to receive the DC voltage and provide a supply voltage to the light source. The supply assembly unit includes: a voltage up-converter configured to convert the DC voltage to a supply voltage, a voltage down-converter configured to convert the DC voltage to a supply voltage, and a voltage controller unit configured to control the voltage up-converter and the voltage down-converter.

### FIELD

The disclosure relates to a supply assembly unit for one or more light sources of an intraoral scanning device for scanning a dental object.

### BACKGROUND

An intraoral scanning device is configured to perform a scan of a dental object. The Intraoral scanning device scans by projecting light and capture the reflected light from the dental object. The scanning methodology are getting more complex throughout the years and that may include scanning with the use of multiple light sources with different wavelengths. To keep the real time scanning behaviour of the intraoral scanning device a fast processor is needed and a fast switching between the multiple light sources. Furthermore, the power consumption should also be reduced as more and more features are being added to the intraoral scanning device.

### SUMMARY

It is an aspect of the present disclosure to obtain an intraoral scanning device for eliminating the means for switching on and off the power supply to one or more light sources while still effecting a modulation of the current to the one or more light sources.

A further aspect of the present disclosure is to obtain an intraoral scanning device with a fast on and off switching of a group of light sources of the one or more light sources that is suitable for performing scanning with different modalities. The modalities may include a first light sources configured to emit light within a first wavelength range and then at least a second light source configured to emit light within a second wavelength range.

A yet another aspect is to provide an intraoral scanning device with a supply assembly unit for the one or more light sources that is simple to manufacture and cost efficient.

An even further aspect is to provide a more power efficient intraoral scanning device.

According to the aspect, an intraoral scanning device is disclosed. The intraoral scanning device may be configured to acquire intraoral scan data from a three-dimensional dental object. The three-dimensional object may be a tooth, teeth and/or gingival of a patient's mouth. The intraoral scanning device may include a projector unit configured to emit light at least onto a dental object of a patient, and wherein the projector unit includes one or more light sources. The one or more light sources may include at least one light emitting diode (LED) configured to emit light having a first wavelength range.

The one or more light sources may include a second light source configured to emit light having an emission maximum in a first subrange of the first wavelength range.

The one or more light sources may include a second light source adapted to emit light having an emission maximum in a first subrange of the first wavelength range The one or more light sources may include a second light source configured to emit light having a second wavelength range, and wherein the first and the second wavelength range comprise different wavelengths.

The one or more light sources may be configured to emit light having a first wavelength range, and wherein the first wavelength range may be characterized by having a Color-Rendering-Index (CRI) of at least 70. The advantage of having a CRI of at least 70 provides an intraoral scanning device that is able to reveal the colors of a dental object that is faithful to the right color of the dental object.

The one or more light sources may be a light emitting diode (LED). The one or more light sources may include a first group of light sources, wherein the first group of light sources may be configured to emit light within a first wavelength range. The one or more light sources may include a second group of light sources, wherein the second group of light sources may be configured to emit light within a second wavelength range. The one or more light sources may include further groups of light sources that are configured to emit light within different wavelength ranges. The light sources of a group of light sources may be connected in a series arrangement. The one or more light sources may include a first light source that is configured to emit light within a first wavelength range, and the one or more light sources may include a second light source that is configured to emit light within a second wavelength range. The first wavelength range and the second wavelength range may be different. The intraoral scanning device may be configured to perform a scan of a dental object by changing the wavelength of the emitted light. For example, the first wavelength range may include infrared wavelengths and the second wavelength range may include white wavelengths and/or coloured wavelengths, such as red, blue, or green. In a scanning situation the intraoral scanning device may shifts between the infrared and the white light.

The one or more light sources may include a laser that is configured to emit light at wavelengths such as red, blue, green, white and infrared. The one or more light sources may include a plurality of lasers configured to emit light at different wavelengths, such as red, blue, green and infrared.

The intraoral scanning device may further comprise an image sensor configured to acquire reflected light from at least the dental object. The image sensor may be a charge-coupled (CCD) image sensor, an active-pixel (CMOS) image sensor, and/or a hybrid CCD and CMOS image sensor. The image sensor may be a monochrome sensor or a color sensor.

The intraoral scanning device may include a processing unit configured to process the acquired reflected light into two-dimensional (2D) intraoral scan data and/or three-dimensional (3D) intraoral scan data. The 2D intraoral scan data may be suitable for generating three-dimension model of the dental object. The processing unti maybe configured to perform a quality improving image processing of the 2D intraoral scan data and based on the improved 2D intraoral scan data the processing unit is configured to generate a three-dimensional model of the dental object. The three-dimensional model may depict a patient's mouth including teeth and gingival. In another example, the three-dimensional model may be of an impression of a patent's mouth.

The processing unit may be operating in a real time which means that the acquired reflected light is being processed within milliseconds into 2D intraoral scan data and/or 3D intraoral scan data, the processed data is available virtually immediately to be graphically displayed un a displaying unit.

The processing unit may be configured to determine, in real time, surface information from the acquired reflected light and generate the 2D intraoral scan data and/or the 3D intraoral scan data.

The processing unit may be configured to determine, in real time, surface information from the acquired reflected light and generate a three-dimensional (3D) surface model of the dental object using the surface information. The 3D surface model may be determined based on a volumetric method that includes stitching of 2D intraoral scan data and/or 3D intraoral scan data.

The intraoral scanning device may include a wireless interface that is configured to transmit real time the three-dimensional (3D) surface model. The intraoral scanning device may transfer via the wireless interface the data or the model to an external device. The external device may be configured to display the received data and/or the model. In one example the intraoral scanning device may transmit 2D intraoral scan data which is either processed by the intraoral scanning device into 2D images ready to be displayed or into raw 2D images where the 2D images are not ready to be displayed but only ready for being transmitted wirelessly to the external device. In this example, the external device may be configured to perform an additional processing of the received 2D intraoral scan data either into 3D intraoral scan data or a 3D surface model representing the dental object being scanned. In another example, the external device may transmit 3D intraoral scan data to the external, device, and in this example, the external device is configured to display the 3D intraoral scan data or perform an additional processing of the 3D intraoral scan data into a 3D surface model. In yet another example, the external device may receive a 3D surface model from the intraoral scanning device, and the 3D surface model is ready to be displayed by the external device.

The intraoral scanning device may include a battery unit configured to power the intraoral scanning device. The battery unit may be configured to supply a DC voltage. The battery unit may include a single cell or multiple cells connected in series. The intraoral scanning device may include a direct current voltage source having a first and a second supply terminal. The battery unit may include one or more of the following cells:
Lithium ion,
Nanotubes lithium ion,
Zinc-manganese oxide,
Zinc-air,
Organosilicon electrolyte,
Gold nanowire gel electrolyte,
Tanktwo String,
Silicon anode lithium ion,
Lithium-sulphur, and
Solid state lithium-ion.

The intraoral scanning device may include a supply assembly unit configured to receive the DC voltage and provide a supply voltage to the one or more light sources. The supply assembly unit may include multiple units arranged within a single component or distributed within multiple components. The supply assembly unit mainly refers to that the components of the supply assembly unit operate as a unit interchanging signals, forwarding signals in between the components, and/or receiving/transmitting signals from/to at least other components of the supply assembly unit.

The supply assembly unit may include a voltage up-converter configured to convert the DC voltage to a supply voltage, wherein the DC voltage is lower than the supply voltage, a voltage down-converter configured to convert the DC voltage to a supply voltage such that the DC voltage is higher than the supply voltage, and a voltage controller unit configured to control the voltage up-converter and the voltage down-converter.

The voltage controller unit may be configured to control the voltage up-converter and the voltage down-converter via a control signal that may include an enablement signal and a current magnitude signal to the one or more light sources. The enablement signal indicates whether the one or more light sources should be on or off, and the current magnitude signal sets the current level of the turned on one or more light sources.

The voltage controller unit may be configured to control the voltage up-converter and the voltage down-converter based on a scan sequence. The scan sequence may be stored in a memory of the intraoral scanner or the intraoral scanner system. The scan sequence determines when and which of the one or more light sources should be turned on and off. For example, the one or more light sources may include a group of white LED sources and a single Infrared LED source, and during the scan sequence, the intraoral scanning device is configured to switch between the group of white LED sources and the single Infrared (IR) LED source. The fast on-off switching allows capturing multiple images of an object with different light sources having different wavelengths. The fast on-off switching makes it possible to capture intraoral scan data with the white LED sources and another intraoral scan data with the IR LED source, and both the intraoral scan and the another intraoral scan data includes image data that correlates to the same object. Without the fast on-off switching, further and more complexed image processing is needed for correlating the intraoral scan data and the another intraoral scan data.

The voltage controller unit may be configured to control the voltage up-converter and the voltage down-converter by the timing of when each of the one or more light sources is turned on and off, i.e. an on-off timing. The scan sequence may further include a current level of each of the one or more light sources. The timing and the current level for each of the one or more light sources may be stored in a memory of the intraoral scanner or the intraoral scanner system.

In one example, the scan sequence may include a first sequence of white pulses being emitted and a subsequent scan sequence, i.e. a second scan sequence, which may include white pulses and blue pulses switched on and off after each other. In another example, the second scan sequence may include white pulses, blue pulses, and infrared pulses being switched on and off after each other. In yet another example, the second scan sequence may include white pulses and blue pulses switched on and off after each other while the IR power is constant at a certain current level.

The one or more light sources may be turned off. Turned off may mean turned down to a current level which makes the light source irrelevant for the scanning, i.e. the light source is passive.

The voltage controller unit may be configured to measure a current magnitude level of the one or more light sources for the purpose of controlling switches of the voltage up-converter and the voltage down-converter. The switches may include at least a down-controllable switch and at least an up-controllable switch.

The voltage controller unit may be configured to control a down-controllable switch or a group of down-controllable switches including the first, a second and/or a third down-controllable switch. The voltage down-converter may include one or more down-controllable switches The voltage controller unit may be configured to control an up-controllable switch or a group of up-controllable switches including the first, a second and/or a third up-controllable switch.

The voltage controller unit may be configured to control a down-controllable switch and/or an up-controllable switch such that the measured current magnitude of a current to the one or more light sources matches the current magnitude signal.

The voltage controller unit may be configured to control a current magnitude of a current to the one or more light sources by applying a pulse-width modulated switching signal to the down-controllable switch and/or the up-controllable switch of the voltage down-converter and/or the voltage up-converter, respectively. A width of the pulses of the pulse-width modulated switching signal determines a current magnitude of the current to the one or more light sources.

The intraoral scanning device may comprise a group of light sources of the one or more light sources that may be connected to the supply assembly unit.

The group of light sources of the one or more light sources may be connected to another supply assembly unit, and wherein the another-supply assembly unit includes; a voltage up-converter configured to convert the DC voltage to a supply voltage, wherein the DC voltage is lower than the supply voltage, and a voltage controller unit configured to control the voltage up-converter. The intraoral scanning device may then include a group of whit Light Emitting Diodes (LEDs) connected to the supply assembly unit and a single infrared LED being connected to a voltage down-converter of the intraoral scanning device.

The voltage down-converter and the voltage up-converter may be two separate components where a group of light sources and a single light source of the intraoral scanning device shares a voltage down-converter, and the group of light sources may be further connected to a voltage up-converter.

The voltage up-converter and the voltage down-convert may be merged into a main voltage converter. Thereby, the group of the light sources and the single light source may be connected to the main voltage converter. The group of the light sources and the single light source is part of the one or more light sources.

The voltage down-converter may include input down-terminals configured to receive the DC voltage and output down-terminals configured to transmit the supply voltage to the one or more light sources. The voltage down-converter further includes an LC-circuit connected to the output down-terminals, a first down-controllable switch connected to a first down-node of the LC-circuit, and wherein the first down-controllable switch is configured to receive the DC voltage from at least one of the input down-terminals and provide an input voltage to the LC-circuit via the first down-node, and wherein the voltage controller unit may be configured to control the first down-controllable switch, and wherein the LC-circuit provides the supply voltage to the output down-terminals based on the input voltage. The schematic of the voltage down-converter is simple and cheaper to produce, as the solution includes a single switch rather than multiple switches.

The voltage down-converter may be a version of a buck converter.

Optionally, a down-diode may be connected to the first down-node and a second down-node of the LC-circuit, and another input of the input down-terminals is connected to the second down-node. The down-diode may be replaced by a second down-controllable switch being controlled by the voltage controller unit. The controlling of the first and the second down-controllable switches may be synchronously, meaning that both switches are being triggered into either on or off at the same time or about the same time.

When the voltage down-converter includes two switches then the voltage down-converter is a version of a synchronous buck converter.

The voltage up-converter may include input up-terminals configured to receive the DC voltage and output up-terminals configured to transmit the supply voltage. The voltage up-converter may include a capacitor connected to the output up-terminals, an inductor connected to a first input of the input up-terminals, and wherein the inductor may be configured to receive the DC voltage from the first input of the input up-terminals and provide a first input voltage to a first up-node. The voltage up-converter may further include a first up-controllable switch connected to the capacitor and the inductor via the first up-node, and wherein the first up-controllable switch may be configured to receive the first input voltage via the first up-node and provide a second input voltage to the capacitor via the first up-node, and the voltage controller unit may be configured to control the first up-controllable switch, and wherein the capacitor provides the supply voltage based on the second input voltage to the output up-terminals.

The voltage up-converter may include input up-terminals configured to receive the DC voltage and output up-terminals configured to transmit the supply voltage. The voltage up-converter may include a capacitor connected across the output up-terminals, an inductor connected to a first input of the input up-terminals, and wherein the inductor may be configured to receive the DC voltage from the first input of the input up-terminals and provide a first input voltage to a first up-node. The voltage up-converter may further include a first up-controllable switch connected to the inductor and a capacitor via a first up-node, and wherein the first up-controllable switch may be configured to receive the first input voltage via the first up-node and provide a second input voltage to the capacitor via the first up-node, and the voltage controller unit may be configured to control the first up-controllable switch, and wherein the capacitor provides the supply voltage based on the second input voltage to the output up-terminals.

The voltage up-converter may be a version of a boost converter.

An up-diode may be connected to the first up-node and a second up-node of the voltage up-converter, and wherein a first side of the capacitor may be connected to the second up-node. The up-diode may be replaced by a second up-controllable switch being controlled by the voltage controller unit. The controlling of the first and the second up-controllable switch may be synchronously, meaning that both switches are being triggered into either on or off at the same time or about the same time.

When the voltage up-converter includes two switches then the voltage up-converter is a version of a synchronous boost converter.

The up-diode and the down-diode may be a diode.

The voltage down-converter may further include a second down-controllable switch connected to the first down-controllable switch and the LC circuit via the first down-node, and wherein the first and second down-controllable switch are controlled by the voltage controller unit. The controlling of the first and second down-controllable switch are synchronously controlled by the voltage controller unit, meaning that both switches are being triggered into either on or off at the same time or about the same time. The voltage-down converter may be a synchronous buck-converter. The synchronous buck-converter has a reduced power loss in comparison to the buck converter.

The triggering of the switches may be performed by the control signals transmitted by the voltage controller unit.

The voltage up-converter may further include a second up-controllable switch connected to the first up-node and to a second up-node of the voltage up-converter, wherein the capacitor may be connected to the second up-node, and wherein the first and the second up-controllable switch are controlled by the voltage controller unit. The controlling of the first and second up-controllable switch may be controlled synchronously by the voltage controller unit, meaning that both switches are being triggered into either on or off at the same time or about the same time. The voltage up-converter may be a synchronous boost-converter. The synchronous boost-converter has a reduced power loss in comparison to the boost converter.

The voltage controller unit may include a plurality of voltage controllers, and where the plurality of voltage controllers may include a voltage down-controller configured to control one or more down-controllable switches of the voltage down-converter, a voltage up-controller configured to control one or more up-controllable switches of the voltage up-converter, and/or a main voltage controller configured to control one or more controllable switches of the main voltage converter.

The plurality of voltage controller may be distributed into different units or within a unit. The plurality of voltage controller may be a single unit or multiple units.

The voltage controller unit may be configured to control one or more controllable switches of the main voltage converter.

The main voltage converter may include the voltage up-converter, wherein the first up-controllable switch may be further connected directly to a second input of the input-up terminals, and the first input of the input up-terminals may further be connected directly to the capacitor. The advantage of the main voltage converter is configured to boost or buck the DC voltage to the supply voltage which is either larger or small than the DC voltage.

The main voltage converter includes a voltage converter that is configured to both down convert and up convert the DC voltage to a supply voltage level.

The LC-circuit of the voltage down-converter includes a down-inductor and a down-capacitor connected. In the main voltage converter, the inductor of the voltage up-converter may be the down-inductor, which means that the voltage down-converter and the voltage up-converter shares the same inductor.

In the main voltage converter, the first input of the input up-terminals may be direct connected to a second side of the capacitor, and wherein the first up-node may be connected to a first side of the capacitor.

The main voltage converter may include a second up-controllable switch, and the second up-controllable switch may be connected to the first up-controllable switch and the capacitor. The second up-controllable switch may be connected to the first up-node and the second up-node. The second up-controllable switch may replace the up-diode. The first up-controllable switch and the second up-controllable switch are controlled by the voltage controller unit. The main voltage converter is a buck-boost converter. The advantage of having a buck-boost converter in relation to a solution with two separate converters being connected in a manner that the DC voltage is either first boosted and then bucked, or vice versa, is the reduced complexity as less components are needed. Furthermore, the power consumption is also reduced as components are being shared between the voltage down-and voltage up-converter.

The first up-controllable switch and the second up-controllable switch may be synchronously controlled by the voltage controller unit. Thereby, obtaining a reduced power consumption in comparison to not having a synchronized controlling of the switches. The main voltage is a synchronous buck-boost voltage converter.

The main voltage converter may include a third up-controllable switch, and wherein the capacitor may be connected to a first output of the output up-terminals via a second up-node of the main voltage converter, and the third up-controllable switch is connected to the capacitor via the second up-node, and wherein the voltage controller unit is configured to control the first, the second and the third up-controllable switch. The third up-controllable switch is connected to the first output of the output up-terminals via the second up-node, and thereby, a faster on-off switching of the one or more light sources is obtained in relation to a solution where the on-off switching of the one or more light sources is determined by a discharge time of the capacitor. The faster on-off switching of the one or more light sources makes the main voltage converter for an intraoral scanning device that is configured to scan in real time with light sources having different wavelengths. For example, the one or more light sources may include a group of white LED sources and a single Infrared LED source, and during a scan, the intraoral scanning device is configured to switch between the group of white LED sources and the single Infrared (IR) LED source. The fast on-off switching allows capturing multiple images of an object with different light sources having different wavelengths. The fast on-off switching makes it possible to capture intraoral scan data with the white LED sources and another intraoral scan data with the IR LED source, and both the intraoral scan and the another intraoral scan data includes image data that correlates to the same object. Without the fast on-off switching, further and more complexed image processing is needed for correlating the intraoral scan data and the another intraoral scan data.

The voltage up-converter may further include a third up-controllable switch connected between the second up-node and the output up-terminals, and wherein the first, the second and the third up-controllable switch are controlled by the voltage controller unit. The controlling of the first, the second and third up-controllable switch are controlled synchronously. The third up-controllable switch is connected to the first output of the output up-terminals via the second up-node, and thereby, a faster on-off switching of the one or more light sources is obtained in relation to a solution where the on-off switching of the one or more light sources is determined by a discharge time of the capacitor. The faster on-off switching of the one or more light sources makes the main voltage converter for an intraoral scanning device that is configured to scan in real time with light sources having different wavelengths. For example, the one or more light sources may include a group of white LED sources and a single Infrared LED source, and during a scan, the intraoral scanning device is configured to switch between the group of white LED sources and the single Infrared (IR) LED source. The fast on-off switching allows capturing multiple images of an object with different light sources having different wavelengths. The fast on-off switching makes it possible to capture intraoral scan data with the white LED sources and another intraoral scan data with the IR LED source, and both the intraoral scan and the another intraoral scan data includes image data that correlates to the same object. Without the fast on-off switching, further and more complexed image processing is needed for correlating the intraoral scan data and the another intraoral scan data.

The voltage controller unit includes a plurality of voltage controller, and where the plurality of voltage controller includes a main voltage controller and a voltage up-controller, and wherein the main voltage controller may be configured to control the controllable switches of the main voltage converter, and the voltage up-controller may be configured to control the controllable switches, i.e. the up-controllable switches, of the voltage up-converter. In this example, the intraoral scanning device may include a light source that is configured to receive a supply voltage from the main voltage converter, and furthermore, a group of light sources is configured to receive a supply voltage from the voltage up-converter. The group of light sources may include white LED sources and the light source may include an Infrared light source. The group of light sources and the light source may be part of the one or more light sources.

The down-controllable switch may be the first, a second and a third down-controllable switch is a transistor, and an up-controllable switch may be the first, a second and a third up-controllable switch is a transistor.

The first down-controllable switch may be a transistor or a pulse width switch, a low-frequency pulse width switch, a high-frequency pulse width switch,

An intraoral scanning system may include the intraoral scanning device and at least a display unit configured to display the 2D intraoral scan data and/or the 3D intraoral scan data.

### BRIEF DESCRIPTION OF THE FIGURES

Aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIGS. 1A and 1B illustrate an example of an intraoral scanning device and an intraoral scanning system, respectively;

FIGS. 2A to 2E illustrates an example of a voltage up-converter, a voltage down-converter and a main voltage converter;

FIGS. 3A and 3B illustrate an example of a voltage up-converter and a voltage down-converter;

FIGS. 4A and 4B illustrate an example of a voltage up-converter and a voltage down-converter;

FIGS. 5A and 5B illustrate an example of a main voltage converter;

FIGS. 6A and 6B illustrate another example of a main voltage converter;

FIG. 7 illustrate an example of a supply assembly unit; and

FIG. 8 illustrate a normalized power spectrum as a function of wavelengths of an LED.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the devices, systems, mediums, programs and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A scanning for providing intra-oral scan data may be performed by a dental scanning system that may include an intraoral scanning device such as the TRIOS series scanners from 3Shape A/S. The dental scanning system may include a wireless capability as provided by a wireless network unit. The scanning device may employ a scanning principle such as triangulation-based scanning, confocal scanning, focus scanning, ultrasound scanning, x-ray scanning, stereo vision, structure from motion, optical coherent tomography OCT, or any other scanning principle. In an embodiment, the scanning device is capable of obtaining surface information by operated by projecting a pattern and translating a focus plane along an optical axis of the scanning device and capturing a plurality of 2D images at different focus plane positions such that each series of captured 2D images corresponding to each focus plane forms a stack of 2D images. The acquired 2D images are also referred to herein as raw 2D images, wherein raw in this context means that the images have not been subject to image processing. The focus plane position is preferably shifted along the optical axis of the scanning system, such that 2D images captured at a number of focus plane positions along the optical axis form said stack of 2D images (also referred to herein as a sub-scan) for a given view of the object, i.e. for a given arrangement of the scanning system relative to the object. After moving the scanning device relative to the object or imaging the object at a different view, a new stack of 2D images for that view may be captured. The focus plane position may be varied by means of at least one focus element, e.g., a moving focus lens. The scanning device is generally moved and angled relative to the dentition during a scanning session, such that at least some sets of sub-scans overlap at least partially, in order to enable reconstruction of the digital dental 3D model by stitching overlapping subscans together in real-time and display the progress of the virtual 3D model on a display as a feedback to the user. The result of stitching is the digital 3D representation of a surface larger than that which can be captured by a single sub-scan, i.e. which is larger than the field of view of the 3D scanning device. Stitching, also known as registration and fusion, works by identifying overlapping regions of 3D surface in various sub-scans and transforming sub-scans to a common coordinate system such that the overlapping regions match, finally yielding the digital 3D model. An Iterative Closest Point (ICP) algorithm may be used for this purpose. Another example of a scanning device is a triangulation scanner, where a time varying pattern is projected onto the dental object and a sequence of images of the different pattern configurations are acquired by one or more cameras located at an angle relative to the projector unit.

Color texture of the dental object may be acquired by illuminating the object using different monochromatic colors such as individual red, green and blue colors or my illuminating the object using multichromatic light such as white light. A 2D image may be acquired during a flash of white light.

Generally the process of obtaining surface information in real time of a dental object to be scanned requires the scanning device to illuminate the surface and acquire high number of 2D images. Typically a high speed camera is used with a framerate of 300-2000 2D frames pr second dependent on the technology and 2D image resolution. The high amount of image data needed to be handled by the scanning device to eighter directly forward the raw image data stream to an external processing device or performing some image processing before transmitting the data to an external device or display. This process requires that multiple electronic components inside the scanner is operating with a high workload thus requiring a high demand of current.

The scanning device comprises one or more light projectors configured to generate an illumination pattern to be projected on a three-dimensional dental object during a scanning session. The light projector(s) preferably comprises a light source, a mask having a spatial pattern, and one or more lenses such as collimation lenses or projection lenses. The light source may be configured to generate light of a single wavelength or a combination of wavelengths (mono-or polychromatic). The combination of wavelengths may be produced by using a light source configured to produce light (such as white light) comprising different wavelengths. Alternatively, the light projector(s) may comprise multiple light sources such as LEDs individually producing light of different wavelengths (such as red, green, and blue) that may be combined to form light comprising the different wavelengths. Thus, the light produced by the light source may be defined by a wavelength defining a specific color, or a range of different wavelengths defining a combination of colors such as white light. In an embodiment, the scanning device comprises a light source configured for exciting fluorescent material of the teeth to obtain fluorescence data from the dental object. Such a light source may be configured to produce a narrow range of wavelengths. In another embodiment, the light from the light source is infrared (IR) light, which is capable of penetrating dental tissue. The light projector(s) may be DLP projectors using a micro mirror array for generating a time varying pattern, or a diffractive optical element (DOF), or back-lit mask projectors, wherein the light source is placed behind a mask having a spatial pattern, whereby the light projected on the surface of the dental object is patterned. The back-lit mask projector may comprise a collimation lens for collimating the light from the light source, said collimation lens being placed between the light source and the mask. The mask may have a checkerboard pattern, such that the generated illumination pattern is a checkerboard pattern. Alternatively, the mask may feature other patterns such as lines or dots, etc.

The scanning device preferably further comprises optical components for directing the light from the light source to the surface of the dental object. The specific arrangement of the optical components depends on whether the scanning device is a focus scanning apparatus, a scanning device using triangulation, or any other type of scanning device. A focus scanning apparatus is further described in EP 2 442 720 B1 by the same applicant, which is incorporated herein in its entirety.

The light reflected from the dental object in response to the illumination of the dental object is directed, using optical components of the scanning device, towards the image sensor(s). The image sensor(s) are configured to generate a plurality of images based on the incoming light received from the illuminated dental object. The image sensor may be a high-speed image sensor such as an image sensor configured for acquiring images with exposures of less than 1/1000 second or frame rates in excess of 250 frames pr. second (fps). As an example, the image sensor may be a rolling shutter (CCD) or global shutter sensor (CMOS). The image sensor(s) may be a monochrome sensor including a color filter array such as a Bayer filter and/or additional filters that may be configured to substantially remove one or more color components from the reflected light and retain only the other non-removed components prior to conversion of the reflected light into an electrical signal. For example, such additional filters may be used to remove a certain part of a white light spectrum, such as a blue component, and retain only red and green components from a signal generated in response to exciting fluorescent material of the teeth.

The network unit may be configured to connect the dental scanning system to a network comprising a plurality of network elements including at least one network element configured to receive the processed data. The network unit may include a wireless network unit or a wired network unit. The wireless network unit is configured to wirelessly connect the dental scanning system to the network comprising the plurality of network elements including the at least one network element configured to receive the processed data. The wired network unit is configured to establish a wired connection between the dental scanning system and the network comprising the plurality of network elements including the at least one network element configured to receive the processed data.

The dental scanning system preferably further comprises a processor configured to generate scan data (such as extra-oral scan data and/or intra-oral scan data) by processing the two-dimensional (2D) images acquired by the scanning device. The processor may be part of the scanning device. As an example, the processor may comprise a Field-programmable gate array (FPGA) and/or an Advanced RISC Machines (ARM) processor located on the scanning device. The scan data comprises information relating to the three-dimensional dental object. The scan data may comprise any of: 2D images, 3D point clouds, depth data, texture data, intensity data, color data, and/or combinations thereof. As an example, the scan data may comprise one or more point clouds, wherein each point cloud comprises a set of 3D points describing the three-dimensional dental object. As another example, the scan data may comprise images, each image comprising image data e.g. described by image coordinates and a timestamp (x, y, t), wherein depth information can be inferred from the timestamp. The image sensor(s) of the scanning device may acquire a plurality of raw 2D images of the dental object in response to illuminating said object using the one or more light projectors. The plurality of raw 2D images may also be referred to herein as a stack of 2D images. The 2D images may subsequently be provided as input to the processor, which processes the 2D images to generate scan data. The processing of the 2D images may comprise the step of determining which part of each of the 2D images are in focus in order to deduce/generate depth information from the images. The depth information may be used to generate 3D point clouds comprising a set of 3D points in space, e.g., described by cartesian coordinates (x, y, z). The 3D point clouds may be generated by the processor or by another processing unit. Each 2D/3D point may furthermore comprise a timestamp that indicates when the 2D/3D point was recorded, i.e., from which image in the stack of 2D images the point originates. The timestamp is correlated with the z-coordinate of the 3D points, i.e., the z-coordinate may be inferred from the timestamp. Accordingly, the output of the processor is the scan data, and the scan data may comprise image data and/or depth data, e.g. described by image coordinates and a timestamp (x, y, t) or alternatively described as (x, y, z). The scanning device may be configured to transmit other types of data in addition to the scan data. Examples of data include 3D information, texture information such as infra-red (IR) images, fluorescence images, reflectance color images, x-ray images, and/or combinations thereof.

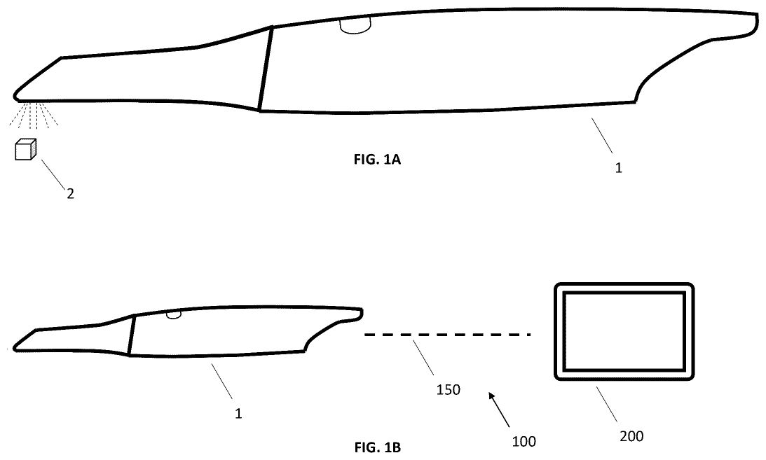

FIG. 1A illustrates an intraoral scanning device 1 that is configured to acquire intraoral scan data from a three-dimensional dental object 2. The intraoral scanning device 1 is a handheld device which has a tip that is arranged, for example, within a mouth of a patient and light is emitted via the tip and onto the dental object 2, and the reflected from the dental object 2 is also received by the tip and forwarded to an image sensor which then convert the reflected light into intraoral scan data. The intraoral scanning device 1 would then process the intraoral scan data into either 2D intraoral scan data, e.g. 2D image data, or 3D intraoral scan data, e.g. 3D image data. In another example, the intraoral scanning device 1 would process the intraoral scan data such that it is suitable for being transferred wirelessly to an external device. FIG. 1B illustrates an intraoral scanning system 100 including the intraoral scanning device 1 and the external device 200 communicating via a wireless link 150.

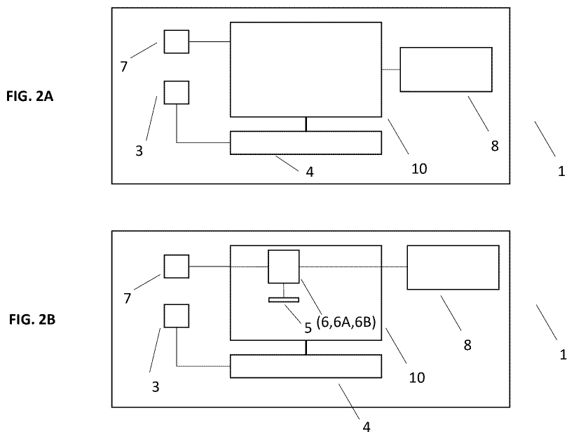

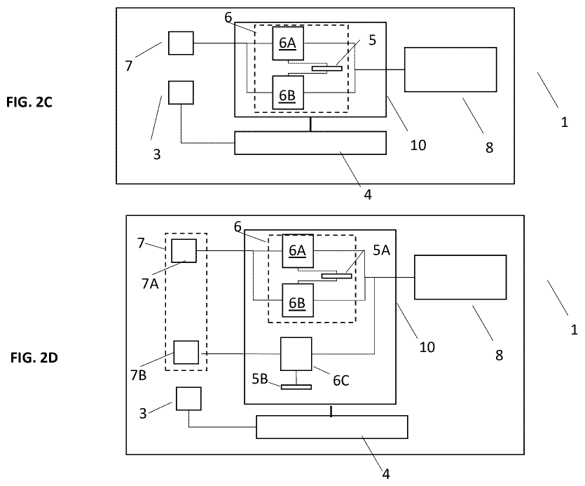

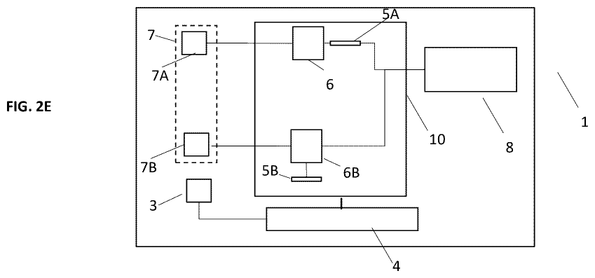

FIGS. 2A-2E illustrate different example of the intraoral scanning device 1. The device 1 includes a projector unit 7 configured to emit light at least onto a dental object of a patient. The projector unit 7 includes one or more light sources. In one example, the one or more light sources include multiple white Light Emitting Diodes (LED) and one or more Infrared LEDs. In another example, the one or more light sources include multiple white Light Emitting Diodes, one or more Infrared LEDs, and one or more coloured LEDs. In yet another example, the one or more light sources include multiple white LED and one or more coloured LEDs. The coloured LEDs may include one or more of red, blue, green and yellow. The device 1 further includes an image sensor 3 configured to acquire reflected light from at least the dental object 2. The device 1 includes a processing unit 4 configured to process the acquired reflected light into 2D intraoral scan data and/or 3D intraoral scan data. The device is powered by a battery 8, and the battery 8 is configured to supply a DC voltage. The device 1 further includes a supply assembly unit 10 configured to receive the DC voltage and provide a supply voltage to the one or more light sources. In FIG. 2B, the supply assembly unit 10 includes a voltage up-converter 6A, a voltage down-converter 6B and/or a main voltage converter 6 which is a combination of a voltage up-converter 6A and a voltage down-converter 6B. The supply assembly unit 10 includers a voltage controller unit 5 configured to control the voltage up-converter 6A, the voltage down-converter 6B, or the main voltage converter 6. The voltage up-converter 6A is configured to convert the DC voltage to a supply voltage, wherein the DC voltage is lower than the supply voltage. The voltage down-converter 6B is configured to convert the DC voltage to a supply voltage such that the DC voltage is higher than the supply voltage. The voltage controller unit is configured to control the voltage up-converter 6, the voltage down-converter 6 and/or the main voltage converter 6. FIG. 2C illustrates the supply assembly unit 10 including the voltage up-converter 6A, the voltage down-converter 6B and the voltage controller unit 5 configured to control the voltage up-converter 6A and the voltage down-converter 6B. In FIG. 2D, the projector unit 7 includes multiple light sources (7A,7B) For example, the projector unit 7 includes a group of light sources 7B and a single light source 7A, and in this example, the group of light sources is connected to the voltage up-converter 6A, and the single light source 7A is connected to the main voltage converter 6 which is a combination of the voltage up-converter 6A and a voltage down-converter 6B. In this example, the main voltage converter 6 is controlled by a voltage controller 5A and the voltage up-converter 6A is controlled by another voltage controller 5B. The voltage controllers (5A,5B) are part of the voltage controller unit 5. FIG. 2E illustrate an example where the supply assembly unit 10 includes another example of the main voltage converter 6 which is a voltage converter configured to down and up convert a voltage from a DC voltage to a supply voltage. The supply assembly unit 10 further includes a voltage up-converter 6A or a voltage down-converter 6B.

The processing unit 4 is configured to determine, in real time, surface information from the acquired reflected light and generate the 2D intraoral scan data and/or the 3D intraoral scan data.

The processing unit 4 is configured to determine, in real time, surface information from the acquired reflected light and generate a three-dimensional (3D) surface model of the dental object using the surface information.

The intraoral scanning device 1 includes a wireless interface (not shown) that is configured to transmit real time the three-dimensional (3D) surface model.

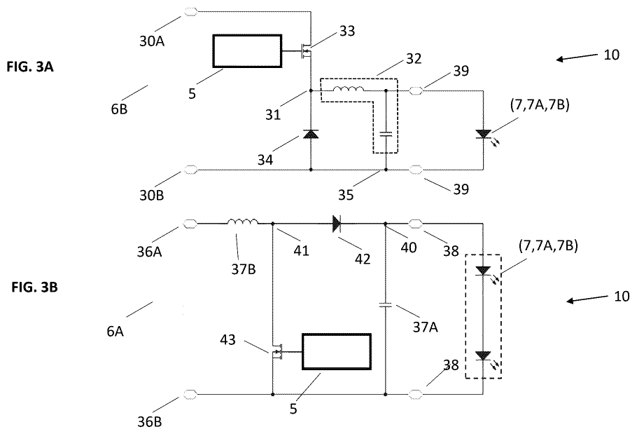

FIGS. 3A and 3B illustrate an example of a voltage down-converter 6B and a voltage up-converter 6A, respectively. In FIG. 3A, the voltage down-converter 6B includes input down-terminals (30A,30B) configured to receive the DC voltage, output down-terminals 39 configured to transmit the supply voltage to the one or more light sources (7,7A,7B), an LC-circuit 32 connected to the output down-terminals 39, a first down-controllable switch 33 connected to a first down-node 31 of the voltage down-converter 6B, and wherein the first down-controllable switch 33 is configured to receive the DC voltage from at least one of the input down-terminals (30A,30B) and provide an input voltage to the LC-circuit 32 via the first down-node 31, and wherein the voltage controller unit 5 is configured to control the first down-controllable switch 33, and wherein the LC-circuit 32 provides the supply voltage to the output down-terminals 39 based on the input voltage. A down-diode 34 may optionally be connected to the first down-node 31 and a second down-node 35 of the LC-circuit 32, and another input 30B of the input down-terminals (30A,30B) is connected to the second down-node 35. The voltage down-converter is a buck voltage converter.

In FIG. 3B, the voltage up-converter 6A includes input up-terminals (36A,36B) configured to receive the DC voltage, output up-terminals 38 configured to transmit the supply voltage, a capacitor 37A connected to the output up-terminals 38, an inductor 37B connected to a first input 36A of the input up-terminals (36A,36B), and wherein the inductor 37B is configured to receive the DC voltage from the first input 36A of the input up-terminals (36A,36B) and provide a first input voltage to a first up-node 41. The voltage up-converter (6,6C) further includes a first up-controllable switch 43 connected to the capacitor 37A and the inductor 37B via the first up-node 41, and wherein the first up-controllable switch 43 is configured to receive the first input voltage via the first up-node 41 and provide a second input voltage to the capacitor 37A via the first up-node 41, and the voltage controller unit 5 is configured to control the first up-controllable switch 43, and wherein the capacitor 37B provides the supply voltage based on the second input voltage to the output up-terminals 38. Optionally, an up-diode 42 is connected to the first up-node 41 and a second up-node 40 of the voltage up-converter 6A, and wherein a first side of the capacitor 37A is connected to the second up-node. The voltage up-converter 6A is a boost voltage converter.

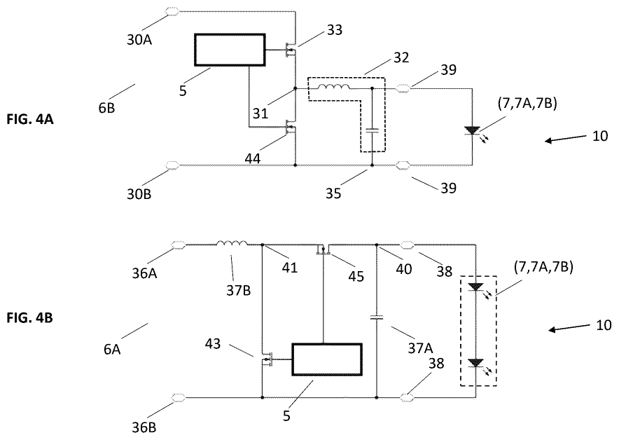

FIGS. 4A and 4B illustrate further example of the voltage down-converter 6B and the voltage up-converter 6A, respectively. In FIG. 4A, the optionally down-diode 34 has been replaced with a second down-controllable switch 44 that is connected to the first down-controllable switch 33 and the LC circuit 32 via the first down-node 31, and wherein the first and second down-controllable switch (33,44) are controlled by the voltage controller unit 5. The voltage-down converter 6B is a synchronous buck-converter. In FIG. 4B, the optionally up-diode 42 is replaced by a second up-controllable switch 45 connected to the first up-node 41 and to a second up-node 40 of the voltage up-converter 6A, wherein the capacitor 37A is connected to the second up-node 40, and wherein the first and the second up-controllable switch (43,45) are controlled by the voltage controller unit 5. The voltage up-converter 6A is a synchronous boost-converter.

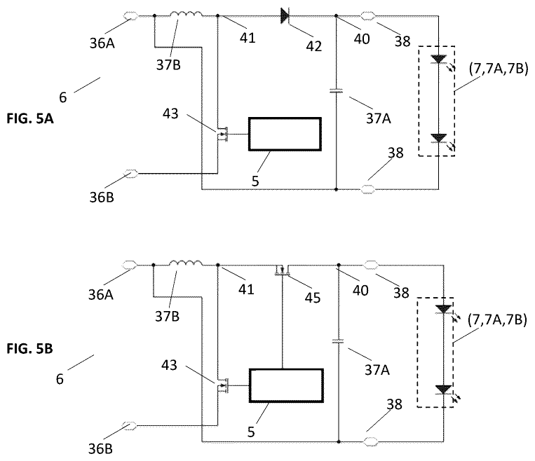

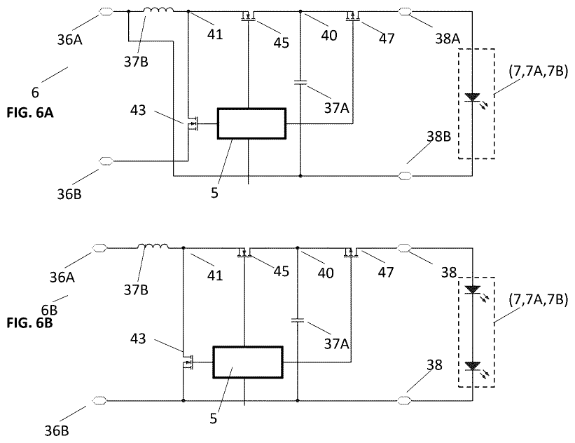

FIGS. 5A and 5B illustrate other examples of the main voltage converter 6. The main voltage converter 6 includes the schematic of the voltage up-converter 6A, wherein the first up-controllable switch 43 is further connected directly to a second input 36B of the input-up terminals, and the first input 36A of the input up-terminals is further connected directly to the capacitor 37A. The main voltage converter 6 is then a combination of the voltage up-converter 6A and the voltage down-converter 6B, as the main voltage converter 6 is configured to convert the DC voltage to a supply voltage, wherein the DC voltage is lower than the supply voltage, or, wherein the DC voltage is higher than the supply voltage. Additionally, the first input 36A of the input up-terminals is direct connected to a second side of the capacitor 37A, and wherein the first up-node 41 is connected to a first side of the capacitor 37A. The main voltage converter 6 illustrated in FIG. 5A is a buck-boost converter. In FIG. 5B, the main voltage converter 6 includes a second up-controllable switch 45, and the second up-controllable switch 45 is connected to the first up-controllable switch 43 and the capacitor 37A, and wherein the first up-controllable switch 43 and the second up-controllable switch 45 are controlled by the voltage controller unit 5. In another example, the first up-controllable switch 43 and the second up-controllable switch 45 are synchronously controlled by the voltage controller unit 5.

FIG. 6A illustrates a different example of the main voltage converter 6. The main voltage converter 6 includes a third up-controllable switch 47, and wherein the capacitor 37A is connected to a first output 38A of the output up-terminals (38A,38B) via a second up-node 40 of the main voltage converter 6, and the third up-controllable switch 47 is connected to the capacitor 37A via the second up-node 40, and wherein the voltage controller unit 6 is configured to control the first, the second and the third up-controllable switch (43,45,47). FIG. 6B illustrates another example of the voltage up-converter 6A which further includes a third up-controllable switch 47 connected between the second up-node 40 and the output up-terminals 38, and wherein the first, the second and the third up-controllable switch (43,45,47) are controlled by the voltage controller unit 5.

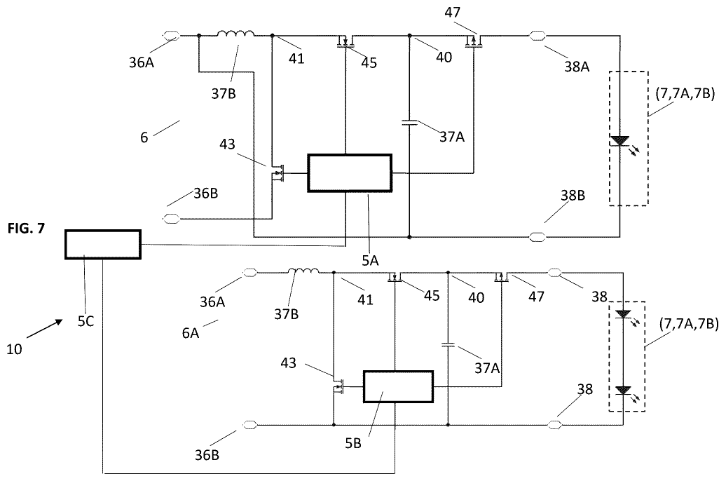

FIG. 7 illustrates an example of the supply assembly unit 10 which includes the main voltage converter 6 and the voltage up-converter 6A. In this present example, the voltage controller unit 5 includes a plurality of voltage controllers (5A, 5B, 5C), and where the plurality of voltage controller (5A,5B,5C) includes a main voltage controller 5A and a voltage up-controller 5B, and wherein the main voltage controller 5A is configured to control the controllable switches of the main voltage converter 6, and the voltage up-controller 5B is configured to control the controllable switches of the voltage up-converter 6A. The plurality of voltage controller (5A,5B,5C) includes a master voltage controller 5C that is configured to forward an enablement signal and a current magnitude to the relevant voltage converter (6, 6A, 6B). The enablement signal indicates whether the one or more light sources (7, 7A, 7B) should be on or off, and the current magnitude signal sets the current level of the turned on one or more light sources. In another example, the voltage up-converter 6A could be replaced by the voltage down-converter 6B.

In general, the voltage controller unit 5 includes a plurality of voltage controllers (5A,5B, 5C), and where the plurality of voltage controllers (5A,5B,5C) includes a voltage down-controller 5B configured to control one or more down-controllable switch (33,44) of the voltage down-converter 6B. Additionally or alternatively, the plurality of voltage controllers (5A, 5B, 5C) includes further a voltage up-controller 6A configured to control one or more up-controllable switches (43,45,47) of the voltage up-converter 6A.

The voltage controller unit 5 is configured to control one or more controllable switches of the main voltage converter 6.

The switches of the voltage converters may be a transistor.

The voltage controller unit 5 is configured to control the voltage up-converter 6A and the voltage down-converter 6B, and the main voltage converter 6 via a control signal including an enablement signal and a current magnitude signal to the one or more light sources (7,7A,7B).

The voltage controller unit 5 is configured to measure a current magnitude level of the one or more light sources (7,7A,7B).

The voltage controller unit 5 is configured to control a down-controllable switch 33 or a group of down-controllable switches (33,44) including the first 33 and the second 44 down-controllable switch, The voltage controller unit 5 is configured to control an up-controllable switch 43 or a group (43,45,47) of up-controllable switches including the first 43, a second 45 and/or a third 47 up-controllable switch.

The voltage controller unit 5 is configured to control a down-controllable switch (33,44) and/or an up-controllable switch (43,45,47) such that the measured current magnitude of a current to the one or more light sources (7,7A,7B) matches the current magnitude signal.

The voltage controller unit 5 is configured to control a current magnitude of a current to the one or more light sources (7,7A,7B) by applying a pulse-width modulated switching signal to the down-controllable switch (33,44) and/or the up-controllable switch (43,45,47) of the voltage down-converter 6B and/or the voltage up-converter 6A, respectively.

The width of the pulses of the pulse-width modulated switching signal determines a current magnitude of the current to the one or more light sources (7,7A,7B).

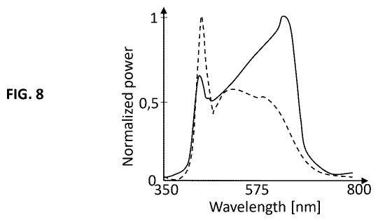

FIG. 8 illustrates a normalized power spectrum of an LED (7,7A,7B) as a function of wavelengths. The solid curve has a Color Rendering Index (CRI) that is not ideal for the purpose of the intraoral scanning device, but, where the dotted line has an ideal CRI. For example, the CRI should be at least 70.

The one or more light sources (7,7A,7B) includes at least one light emitting diode (LED) configured to emit light having a first wavelength range.

The one or more light sources (7,7A,7B) includes a first light source 7A configured to emit light having a first wavelength range, and a second light source 7B configured to emit light having an emission maximum in a first subrange of the first wavelength range.

The one or more light sources (7,7A,7B) includes a second light source 7B configured to emit light having a second wavelength range, and wherein the first and the second wavelength range comprise different wavelengths.

The one or more light sources (7,7A,7B) is configured to emit light having a first wavelength range, and wherein the first wavelength range is characterized by having a Color-Rendering-Index (CRI) of at least 70.

Although some embodiments have been described and shown in detail, the disclosure is not restricted to such details, but may also be embodied in other ways within the scope of the subject matter defined in the following claims. In particular, it is to be understood that other embodiments may be utilized, and structural and functional modifications may be made without departing from the scope of the present invention.

Benefits, other advantages, and solutions to problems have been described herein with regard to specific embodiments. However, the benefits, advantages, solutions to problems, and any component(s)/unit(s) that may cause any benefit, advantage, or solution to occur or become more pronounced are not to be construed as critical, required, or essential features or components/elements of any or all the claims or the invention. The scope of the invention is accordingly to be limited by nothing other than the appended claims, in which reference to an component/unit/element in the singular is not intended to mean “one and only one” unless explicitly so stated, but rather “one or more.” A claim may refer to any of the preceding claims, and “any” is understood to mean “any one or more” of the preceding claims.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Items

Item 1. An intraoral scanning device configured to acquire intraoral scan data from a three-dimensional dental object, the intraoral scanning device includes:
a projector unit configured to emit light at least onto a dental object of a patient, and wherein the projector unit includes one or more light sources;
an image sensor configured to acquire reflected light from at least the dental object;
a processing unit configured to process the acquired reflected light into 2D intraoral scan data and/or 3D intraoral scan data,
a battery configured to supply a DC voltage,
a supply assembly for the projector unit comprising:
   a direct current (DC) voltage source having a first and a second supply terminal;
   a controllable switch connected across the first and second supply terminals of the DC voltage source;
   an inductor connecting the first supply terminal of the DC voltage source to a first output terminal, a node between the one or more light sources and the controllable switch forming a second output terminal, the projector unit being connectable between the first and second output terminals; and
   a controller for controlling the switching of the controllable switch, said controller having means for supplying a dual pulse-width modulated switching signal to said controllable switch at two frequencies including a high frequency pulse-width modulated switching signal component for controlling a magnitude of a light source current in said projector unit, and a low frequency pulse-width modulated switching signal component for controlling a duration of the light source current.

Item 2. The intraoral scanning device according to item 1, wherein the controller further comprises an input for receiving a sensed current indicative of the light source current, and means for modifying said low frequency pulse-width modulated switching signal component in dependence on said sensed current.

Item 3. The intraoral scanning device according to any of the previous items, wherein the controller comprises:
a current source for supplying a reference current;
a source for supplying a high frequency sawtooth signal;
a current mode pulse width modulator coupled to receive said sensed current, said reference current and said high frequency sawtooth signal, said current mode pulse width modulator supplying said high frequency PWM switching signal component;
a source for said low frequency PWM switching signal component; and
an AND-gate having a first input for receiving said high frequency PWM switching signal component, and a second input for receiving said low frequency PWM switching signal component, said AND-gate supplying said dual PWM switching signal.

Item 4. The intraoral scanning device according to item 2, wherein the controller comprises:
an adder for receiving a voltage reference signal and a high frequency sawtooth signal;
a comparator having an inverting input coupled to an output of said adder, and a non-inverting input coupled to receive said sensed current;
an RS flip-flop having a reset input coupled to an output of said comparator and a set input coupled to receive a high frequency clock signal; and
an AND-gate having a first input coupled to an output of said RS flip-flop, and a second input coupled to receive the low frequency PWM switching signal component, said AND-gate supplying said dual PWM switching signal.

Item 5. The intraoral scanning device according to any of the previous items, wherein the controller comprises:
an integrator coupled to receive said sensed current, said integrator forming an average of said sensed current;
a low frequency sawtooth generator having a variable user control input for varying a generated low frequency sawtooth signal;
a first reference current source;
a low frequency pulse width modulator coupled to receive said average sensed current, said low frequency sawtooth signal and said first reference current, said low frequency pulse width modulator varying a pulse width of the generated low frequency PWM switching signal component in dependence on the average sensed current and the low frequency sawtooth signal;
a sample-and-hold circuit also coupled to receive said sensed current, said sample-and-hold circuit having a control input for receiving the low frequency PWM switching signal component as a gate signal, said sample-and-hold circuit supplying a peak current signal of said sensed current;
a second reference current source;
a high frequency sawtooth generator for generating a high frequency sawtooth signal;
a high frequency pulse width modulator coupled to receive said peak current signal, said second reference current and said high frequency sawtooth signal, said high frequency pulse width modulator varying a pulse width of the generated high frequency PWM switching signal component in dependence on the peak current signal and the high frequency sawtooth signal; and
an AND-gate having a first input for receiving the low frequency PWM switching signal component, and a second input for receiving the high frequency PWM switching signal component, said AND-gate supplying said dual PWM switching signal.

Item 6. The intraoral scanning device according to any of the previous items, wherein the controller comprises:
a current source for supplying a reference current;
a source for supplying a high frequency sawtooth signal;
a current mode pulse width modulator coupled to receive said sensed current, said reference current and said high frequency sawtooth signal, said current mode pulse width modulator supplying said high frequency PWM switching signal component;
a source for said low frequency PWM switching signal component; and
an AND-gate having a first input for receiving said high frequency PWM switching signal component, and a second input for receiving said low frequency PWM switching signal component, said AND-gate supplying said dual PWM switching signal.

Item 7. The intraoral scanning device according to item 6, wherein a change in duty cycle of said controllable switch is substantially instantaneous when said dual pulse-width modulated switching signal is applied to said controllable switch.

Item 8. The intraoral scanning device according to any of the previous items, wherein the controller comprises:
an adder for receiving a voltage reference signal and a high frequency sawtooth signal;
a comparator having an inverting input coupled to an output of said adder, and a non-inverting input coupled to receive said sensed current;
an RS flip-flop having a reset input coupled to an output of said comparator and a set input coupled to receive a high frequency clock signal; and
an AND-gate having a first input coupled to an output of said RS flip-flop, and a second input coupled to receive the low frequency PWM switching signal component, said AND-gate supplying said dual PWM switching signal.

Item 9. The intraoral scanning device according to item 8, wherein a change in duty cycle of said controllable switch is substantially instantaneous when said dual pulse-width modulated switching signal is applied to said controllable switch.

Item 10. The intraoral scanning device according to any of the previous items, wherein the controller comprises:
an integrator coupled to receive said sensed current, said integrator forming an average of said sensed current;
a low frequency sawtooth generator having a variable user control input for varying a generated low frequency sawtooth signal;
a first reference current source;
a low frequency pulse width modulator coupled to receive said average sensed current, said low frequency sawtooth signal and said first reference currant, said low frequency pulse width modulator varying a pulse width of the generated low frequency PWM switching signal component in dependence on the average sensed current and the low frequency sawtooth signal;
a sample-and-hold circuit also coupled to receive said sensed current, said sample-and-hold circuit having a control input for receiving the low frequency PWM switching signal component as a gate signal, said sample-and-hold circuit supplying a peak current signal of said sensed current;
a second reference current source;
a high frequency sawtooth generator for generating a high frequency sawtooth signal;
a high frequency pulse width modulator coupled to receive said peak current signal, said second reference current and said high frequency sawtooth signal, said high frequency pulse width modulator varying a pulse width of the generated high frequency PWM switching signal component in dependence on the peak current signal and the high frequency sawtooth signal; and
an AND-gate having a first input for receiving the low frequency PWM switching signal component, and a second input for receiving the high frequency PWM switching signal component, said AND-gate supplying said dual PWM switching signal.

Item 11. The intraoral scanning device according to item 10, wherein a change in duty cycle of said controllable switch is substantially instantaneous when said dual pulse-width modulated switching signal is applied to said controllable switch.

Item 12. The intraoral scanning device according to any of the previous items, wherein the voltage controller unit includes a plurality of voltage controller, and where the plurality of voltage controller includes a main voltage controller and a voltage up-controller, and wherein the main voltage controller is configured to control the controllable switches of the main voltage converter, and the voltage up-controller is configured to control the controllable switches of the voltage up-converter.

Item 13. The intraoral scanning device according to any of the previous items, wherein a down-controllable switch including the first, a second and a third down-controllable switch is a transistor, and an up-controllable switch including the first, a second and a third up-controllable switch is a transistor.

Item 14. The intraoral scanning device according to any of the previous items, wherein the voltage controller unit is configured to control the voltage up-converter, the voltage down-converter and/or the main voltage converter via a control signal including an enablement signal and a current magnitude signal to the one or more light sources.

Item 15. The intraoral scanning device according to any of the previous items, wherein the voltage controller unit is configured to measure a current magnitude level of the one or more light sources.

Item 16. The intraoral scanning device according to any of items 14 and 15, wherein the voltage controller unit is configured to control a down-controllable switch or a group of down-controllable switches including the first, a second and/or a third down-controllable switch, and/or the voltage controller unit is configured to control an up-controllable switch or a group of up-controllable switches including the first, a second and/or a third up-controllable switch.

Item 17. The intraoral scanning device according to items 15 and 16, wherein the voltage controller unit is configured to control a down-controllable switch and/or an up-controllable switch such that the measured current magnitude of a current to the one or more light sources matches the current magnitude signal.

Item 18. The intraoral scanning device according to any of items 14 to 17, wherein the voltage controller unit is configured to control a current magnitude of a current to the one or more light sources by applying a pulse-width modulated switching signal to the down-controllable switch and/or the up-controllable switch of the voltage down-converter and/or the voltage up-converter, respectively.

Item 19. The intraoral scanning device according to item 18, wherein a width of the pulses of the pulse-width modulated switching signal determines a current magnitude of the current to the one or more light sources.

Item 20. The intraoral scanning device according to any of the previous items, wherein the one or more light sources includes at least one light emitting diode (LED) configured to emit light having a first wavelength range.

Item 21. The intraoral scanning device according to item 20, wherein the one or more light sources includes a second light source configured to emit light having an emission maximum in a first subrange of the first wavelength range.

Item 22. The intraoral scanning device according to any of items 20 and 21, wherein the one or more light sources includes a second light source adapted to emit light having an emission maximum in a first subrange of the first wavelength range

Item 23. The intraoral scanning device according to any of items 20 to 22, wherein the one or more light sources includes a second light source configured to emit light having a second wavelength range, and wherein the first and the second wavelength range comprise different wavelengths.

24. The intraoral scanning device according to any of the previous items, the one or more light sources is configured to emit light having a first wavelength range, and wherein the first wavelength range is characterized by having a Color-Rendering-Index (CRI) of at least 70.

Item 25. The intraoral scanning device according to any of the previous items, wherein the processing unit is configured to determine, in real time, surface information from the acquired reflected light and generate the 2D intraoral scan data and/or the 3D intraoral scan data.

Item 26. The intraoral scanning device according to any of the previous items, wherein the processing unit is configured to determine, in real time, surface information from the acquired reflected light and generate a three-dimensional (3D) surface model of the dental object using the surface information.

Item 27. The intraoral scanning device according to item 36, comprising a wireless interface that is configured to transmit real time the three-dimensional (3D) surface model.

Item 28. An intraoral scanning system, comprising;
an intraoral scanning device according to any of the previous items, and
a display unit configured to display the 2D intraoral scan data and/or the 3D intraoral scan data.

1. An intraoral scanning device configured to acquire intraoral scan data from a three-dimensional dental object, the intraoral scanning device includes:
a projector unit configured to emit light at least onto the dental object of a patient based on a scan sequence, and wherein the projector unit includes one or more light sources, and the scan sequence includes a sequence of the emitted light of the one or more light sources;
an image sensor configured to acquire reflected light from at least the dental object;
a processing unit configured to process the acquired reflected light into 2D intraoral scan data and/or 3D intraoral scan data,
a battery unit configured to supply a DC voltage, and
a supply assembly unit configured to receive the DC voltage and provide a supply voltage to the one or more light sources, and the supply assembly unit includes:
a voltage up-converter configured to convert the DC voltage to a supply voltage, wherein the DC voltage is lower than the supply voltage,
a voltage down-converter configured to convert the DC voltage to a supply voltage such that the DC voltage is higher than the supply voltage, and
a voltage controller unit configured to control the voltage up-converter and the voltage down-converter based on the scan sequence.

2. The intraoral scanning device according to claim 1, wherein the scan sequence includes an on-off switching timing of each of the one or more light sources, and wherein the on-off switching timing determines when each of the one or more light sources is switched on and off during the scan sequence.

3. The intraoral scanning device according to claim 1, wherein the scan sequence includes a current level of each of the one or more light sources when turned on, and/or a current level of each of the one or more light sources when turned off.

4. The intraoral scanning device according to claim 1, comprises a group of light sources of the one or more light sources, and wherein the group of light sources is connected to the supply assembly unit, and wherein the group of light sources of the one or more light sources is connected to another supply assembly unit, and wherein the another-supply assembly unit includes;
a voltage up-converter configured to convert the DC voltage to a supply voltage, wherein the DC voltage is lower than the supply voltage, and
a voltage controller unit configured to control the voltage up-converter.

5. The intraoral scanning device according to claim 1, wherein the voltage up-converter and the voltage down-convert are merged into a main voltage converter.

6. The intraoral scanning device according to claim 1, wherein the voltage down-converter includes:
input down-terminals configured to receive the DC voltage,
output down-terminals configured to transmit the supply voltage to the one or more light sources,
an LC-circuit connected to the output down-terminals,
a first down-controllable switch connected to a first down-node of the voltage down-converter, and wherein the first down-controllable switch is configured to receive the DC voltage from at least one of the input down-terminals and provide an input voltage to the LC-circuit via the first down-node, and wherein the voltage controller unit is configured to control the first down-controllable switch, and
wherein the LC-circuit provides the supply voltage to the output down-terminals based on the input voltage.

7. The intraoral scanning device according to claim 1, wherein the voltage up-converter includes:
input up-terminals configured to receive the DC voltage,
output up-terminals configured to transmit the supply voltage,
a capacitor connected to the output up-terminals,
an inductor connected to a first input of the input up-terminals, and wherein the inductor is configured to receive the DC voltage from the first input of the input up-terminals and provide a first input voltage to a first up-node, and
a first up-controllable switch connected to the capacitor and the inductor via the first up-node, and wherein the first up-controllable switch is configured to receive the first input voltage via the first up-node and provide a second input voltage to the capacitor via the first up-node, and the voltage controller unit is configured to control the first up-controllable switch, and
wherein the capacitor provides the supply voltage based on the second input voltage to the output up-terminals.

8. The intraoral scanning device according to claim 6, wherein the voltage down-converter further includes a second down-controllable switch connected to the first down-controllable switch and the LC circuit via the first down-node, and wherein the first and second down-controllable switch are controlled by the voltage controller unit.

9. The intraoral scanning device according to claim 7, wherein the voltage up-converter further includes a second up-controllable switch connected to the first up-node and to a second up-node of the voltage up-converter, wherein the capacitor is connected to the second up-node, and wherein the first and the second up-controllable switch are controlled by the voltage controller unit.

10. The intraoral scanning device according to claim 1, wherein the voltage controller unit includes a plurality of voltage controllers, and where the plurality of voltage controllers includes:
a voltage down-controller configured to control one or more down-controllable switches of the voltage down-converter,
a voltage up-controller configured to control one or more up-controllable switches of the voltage up-converter, and/or
a main voltage controller configured to control one or more controllable switches of the main voltage converter.

11. The intraoral scanning device according to claim 5, wherein the voltage controller unit is configured to control one or more controllable switch of the main voltage converter.

12. The intraoral scanning device according to claim 5, wherein the main voltage converter includes the voltage up-converter, wherein the first up-controllable switch is further connected directly to a second input of the input-up terminals, and the first input of the input up-terminals is further connected directly to the capacitor.

13. The intraoral scanning device according to claim 12, wherein the first input of the input up-terminals is direct connected to a second side of the capacitor, and wherein the first up-node is connected to a first side of the capacitor.

14. The intraoral scanning device according to claim 12, wherein the main voltage converter includes a second up-controllable switch, and the second up-controllable switch is connected to the first up-controllable switch and the capacitor, and wherein the first up-controllable switch and the second up-controllable switch are controlled by the voltage controller unit.

15. The intraoral scanning device according to claim 14, wherein the main voltage converter includes a third up-controllable switch, and wherein the capacitor is connected to a first output of the output up-terminals via a second up-node of the main voltage converter, and the third up-controllable switch is connected to the capacitor via the second up-node, and wherein the voltage controller unit is configured to control the first, the second and the third up-controllable switch.
